(19) United States
(12) Patent Application Publication
(10) Pub. No.: US 2023/0191549 A1
(43) Pub. Date: Jun. 22, 2023

(54) TURRET TOOL COOLING APPARATUS

(71) Applicant: DN SOLUTIONS CO., LTD., Changwon-si (KR)

(72) Inventor: Sungkwon JUNG, Changwon-si (KR)

(21) Appl. No.: 17/920,672

(22) PCT Filed: Apr. 16, 2021
(86) PCT No.: PCT/KR2021/004806

§ 371 Date: Oct. 21, 2022

(30) Foreign Application Priority Data
Apr. 24, 2020 (KR) 10-2020-0050383

(51) Int. Cl. B23Q 11/10; B23Q 16/10

(52) U.S. Cl. CPC B23Q 11/1015; B23Q 16/10

(57) ABSTRACT

The present disclosure provides a turret tool cooling apparatus including a tool stand body, a turret installed on the tool stand body and configured to accommodate a plurality of tools, an indexing unit configured to index the plurality of tools accommodated in the turret, a driving unit installed in the tool stand body and configured to provide rotational power to the indexing unit, and a cooling flow path configured to deliver a cryogenic cooling fluid, which is supplied from a cryogenic cooling fluid storage unit, to one or more tools accommodated in the turret, in which the cooling flow path is disposed to penetrate a part of the indexing unit, such that a cryogenic cooling fluid is consistently supplied even when the turret performs the indexing.

### FIELD OF THE DISCLOSURE

The present disclosure relates to a turret tool cooling apparatus, and more particularly, to a turret tool cooling apparatus for a machine tool for machining a hard-to-cut material, which may be disposed to penetrate a part of an indexing unit having a cooling flow path formed as a rotary union and continuously supply a cryogenic cooling fluid to a tool, which performs machining, without interruption of the cooling flow path even in case that a turret performs an indexing operation, thereby preventing a leak of the cryogenic cooling fluid.

### BACKGROUND OF THE DISCLOSURE

In general, a machine tool refers to a machine used to process metal/non-metal workpieces in a desired shape and dimension using a suitable tool by using various types of cutting or non-cutting methods.

Various types of machine tools including a turning center, a vertical/horizontal machining center, a door-type machining center, a Swiss turning machine, an electric discharge machine, a horizontal NC boring machine, a CNC lathe, and a multi-tasking machining center are being widely used to suit the purpose of the corresponding work in various industrial sites.

The multi-tasking machining center, among the machine tools, refers to a turning center equipped with a multifunctional automatic tool changer (ATC) and a tool magazine in order to perform various types of processing such as turning, drilling, tapping, or milling. In the case of the multi-tasking machining center, an operator manually mounts a tool on a tool magazine when loading the tool required for a machining process or changing the tools.

In general, various types of currently used machine tools each have a control panel to which a numerical control (NC) technology or a computerized numerical control (CNC) technology is applied. The control panel is provided with a multifunctional switch or button, and a monitor.

In addition, the machine tool includes a table on which a material, i.e., a workpiece is seated and which transfers the workpiece to machine the workpiece, a palette used to prepare the workpiece to be machined, a spindle coupled to a tool or the workpiece and configured to be rotated, and a tailstock and a steady rest configured to support the workpiece during the machining process.

In general, the machine tool is provided with a transfer unit configured to transfer the table, a tool post, the spindle, the tailstock, and the steady rest along a transfer shaft in order to perform various types of machining operations.

Further, the machine tool generally uses a plurality of tools in order to perform various types of machining operations, and a tool magazine or a turret is used in the form of a tool storage place for receiving and storing the plurality of tools.

The machine tool uses the plurality of tools in order to perform various types of machining operations, and the tool magazine is used in the form of a tool storage place for receiving and storing the plurality of tools.

In addition, the machine tool is generally equipped with the automatic tool changer (ATC) configured to withdraw a specific tool from the tool magazine or remount the tool on the tool magazine based on an instruction of a numerical control unit in order to improve productivity of the machine tool.

Further, the machine tool is generally equipped with an automatic palette changer (APC) in order to minimize the non-machining time. The automatic palette changer (APC) automatically changes the palettes between a workpiece machining region and a workpiece loading region. The workpiece may be mounted on the palette.

In addition, the machine tools are generally classified broadly into a turning center and a machining center depending on machining methods. In general, the turning center rotates a workpiece, whereas the machining center machines a workpiece by rotating a tool.

The turning center, which is generally called a lathe, refers to a device for machining a workpiece by moving a tool to the workpiece while quickly rotating the workpiece mounted on a spindle.

The turning center is provided with a turret tool stand device used to mount a plurality of tools and index the tools required for the machining process.

That is, indexing refers to a tool change operation of moving one machining tool, which performs an operation at a machining position on the turning center, to a standby position and moving one of the standby tools, which are positioned at a standby position, to the machining position.

As described above, the indexing needs to be performed essentially once or more times to change the tools during the machining process in the machine tool, particularly, the turning center.

In addition, because a hard-to-cut material such as Inconel or titanium required to be subjected to cryogenic machining has low thermal conductivity, a chip and a tool recovers most parts of heat generated during the machining. Because a lifespan is significantly shortened when the tool is heated during the machining, it is necessary to cool the tool during the machining to increase the lifespan.

Moreover, the standby tool needs to be precooled to maximize productivity by reducing a machining standby time.

To cool and precool the tool for machining a hard-to-cut material during the machining as described above, a turret tool cooling apparatus installed in the turning center in the related art cools the tool by supplying a cryogenic cooling fluid such as liquefied nitrogen or liquefied carbon dioxide.

However, the turret tool cooling apparatus in the related art needs to essentially disconnect a cryogenic cooling fluid supply line for supplying the cryogenic cooling fluid and cut off a supply of the fluid at the moment when the turret performs the indexing to change the tools. For this reason, because thermal insulation is not consistently maintained, there is a problem in that the cryogenic cooling fluid from leaking due to cooling or the like.

In addition, because the turret tool cooling apparatus in the related art supplies the cryogenic cooling fluid only to the single tool, the precooling cannot be performed, and the machining time and the standby time for the workpiece are increased. For this reason, there are problems in that productivity deteriorates, the tool lifespan is shortened, and machining costs are increased.

Moreover, because the turret tool cooling apparatus in the related art has a structure in which the cryogenic cooling fluid supply line is complicatedly disposed without being connected directly to the tool, there is a problem in that pipe resistance of a flow path pipe increases, and cooling efficiency decreases.

In addition, because the turret tool cooling apparatus in the related art has a complicated structure, there are problems in that the manufacturing costs and manufacturing time are increased, the size cannot be reduced, the spatial utilization deteriorates, and the maintenance time is increased.

### DISCLOSURE

### SUMMARY

The present disclosure has been made in an effort to solve the above-mentioned problems, and an object of the present disclosure is to provide a turret tool cooling apparatus, in which a main flow path part is disposed to penetrate a shaft part of an indexing unit having a rotary union structure, such that a cryogenic cooling fluid may be continuously supplied directly to a tool, which performs the machining, without separating a cooling flow path or interruption even when the turret performs indexing, thereby preventing a leak of the cryogenic cooling fluid and blocking the introduction of chips. Further, the object of the present disclosure is to provide the turret tool cooling apparatus, in which a structure in which the main flow path part is connected directly to the tool reduces pipe resistance of the main flow path part and maximizes cooling efficiency, and the plurality of main flow path parts and a plurality of auxiliary flow path parts precool the standby tool adjacent to the machining tool and the standby tool to be machined next according to a machining program, such that it is possible to reduce the machining time, maximize the productivity and machining precision, minimize the waste of the cryogenic cooling fluid, and reduce the maintenance costs.

In order to achieve the above-mentioned object, the present disclosure provides a turret tool cooling apparatus including: a tool stand body; a turret installed on the tool stand body and configured to accommodate a plurality of tools; an indexing unit configured to index the plurality of tools accommodated in the turret; a driving unit installed in the tool stand body and configured to provide rotational power to the indexing unit; and a cooling flow path configured to deliver a cryogenic cooling fluid, which is supplied from a cryogenic cooling fluid storage unit, to one or more tools accommodated in the turret, in which the cooling flow path is disposed to penetrate a part of the indexing unit, such that a cryogenic cooling fluid is consistently supplied even when the turret performs the indexing.

According to another exemplary embodiment of the turret tool cooling apparatus, the indexing unit of the turret tool cooling apparatus may include: a housing part installed in the tool stand body; and a shaft part having one side coupled to the housing part, the shaft part installed to extend while penetrating the turret and being configured to be rotated by an operation of the driving unit.

In addition, according to another exemplary embodiment of the turret tool cooling apparatus, the cooling flow path of the turret tool cooling apparatus may include a plurality of main flow path parts each having one side configured to communicate with the cryogenic fluid storage unit, and the other side extending while penetrating the shaft part so as to be adjacent to any one of the plurality of tools radially accommodated in the turret to be divided into angular sections based on a rotation axis.

In addition, according to another exemplary embodiment of the turret tool cooling apparatus, the cooling flow path of the turret tool cooling apparatus may further include one or more auxiliary flow path parts configured to connect tips of the adjacent main flow path parts, from which the cryogenic cooling fluid is discharged, and precool a standby tool with the cryogenic cooling fluid discharged from the tip of the main flow path part that cools a machining tool.

In addition, according to another exemplary embodiment of the turret tool cooling apparatus, the main flow path part of the turret tool cooling apparatus may include: a horizontal portion extending while penetrating the shaft part so as to be parallel to the rotation axis of the shaft part; and a vertical portion bent from the tip of the horizontal portion and extending perpendicularly to the rotation axis of the shaft part.

In addition, according to another exemplary embodiment of the turret tool cooling apparatus, the indexing unit of the turret tool cooling apparatus may further include a bearing part installed between the fixing part and the shaft part and configured to support a rotation of the shaft part.

Because the main flow path part of the turret tool cooling apparatus according to the present disclosure is disposed to penetrate the shaft part of the indexing unit having the rotary union structure, the cryogenic cooling fluid may be continuously supplied directly to the tool, which performs the machining, without separating the cooling flow path or interruption even when the turret performs the indexing. Therefore, it is possible to prevent a leak of the cryogenic cooling fluid and block the introduction of chips.

In addition, the main flow path part of the turret tool cooling apparatus according to the present disclosure has a structure in which the shaft part is connected directly to the tool radially accommodated in the turret divided into the angular sections based on the rotation axis. Therefore, it is possible to maximize the cooling efficiency by reducing the pipe resistance against the cryogenic cooling fluid being delivered to the main flow path part.

Furthermore, according to the turret tool cooling apparatus according to the present disclosure, the plurality of main flow path parts is disposed to be connected directly to the tools radially accommodated in the turret divided into the angular sections based on the rotation axis of the shaft part. The plurality of auxiliary flow path parts is provided between the main flow path parts cool the standby tool adjacent to the machining tool or precool the standby tool to be machined next according to the machining program. Therefore, it is possible to reduce the non-machining time, maximize the productivity, minimize the waste of the cryogenic cooling fluid, increase the tool lifespan, reduce the maintenance costs, improve the machining precision.

Further, according to the turret tool cooling apparatus according to the present disclosure, with the structure in which the main flow path part is connected directly to the tool, it is possible to reduce the size, improve the spatial utilization. Further, it is possible to reduce the manufacturing cost and manufacturing time by eliminating the installation of a separate actuator for connecting and blocking the flow path during the indexing in the related art.

### DESCRIPTION OF THE DRAWINGS

FIG. 1 is a perspective view of a turret tool cooling apparatus according to the present disclosure.

FIG. 2 is a top plan view of the turret tool cooling apparatus according to the present disclosure.

FIG. 3 is a side view of the turret tool cooling apparatus according to the present disclosure.

FIG. 4 is a cross-sectional view taken along line A-A illustrated in FIG. 2.

### DETAILED DESCRIPTION OF CERTAIN INVENTIVE EMBODIMENT

Hereinafter, a turret tool cooling apparatus according to an embodiment of the present disclosure will be described in detail with reference to the drawings. The following exemplary embodiments are provided as examples for fully transferring the spirit of the present disclosure to those skilled in the art. Therefore, the present disclosure is not limited to the exemplary embodiments described below and may be specified as other aspects. Further, in the drawings, a size and a thickness of the apparatus may be exaggerated for convenience. Like reference numerals indicate like constituent elements throughout the specification.

Advantages and features of the present disclosure and methods of achieving the advantages and features will be clear with reference to exemplary embodiments described in detail below together with the accompanying drawings. However, the present disclosure is not limited to the exemplary embodiments disclosed herein but will be implemented in various forms. The exemplary embodiments of the present disclosure are provided so that the present disclosure is completely disclosed, and a person with ordinary skill in the art can fully understand the scope of the present disclosure. The present disclosure will be defined only by the scope of the appended claims. Like reference numerals indicate like constituent elements throughout the specification. In the drawings, sizes and relative sizes of layers and regions may be exaggerated for clarity of description.

The terms used in the present specification are for explaining the exemplary embodiments, not for limiting the present disclosure. Unless particularly stated otherwise in the present specification, a singular form also includes a plural form. The terms such as “comprise (include)” and/or “comprising (including)” used in the specification do not exclude presence or addition of one or more other constituent elements, steps, operations, and/or elements, in addition to the mentioned constituent elements, steps, operations, and/or elements.

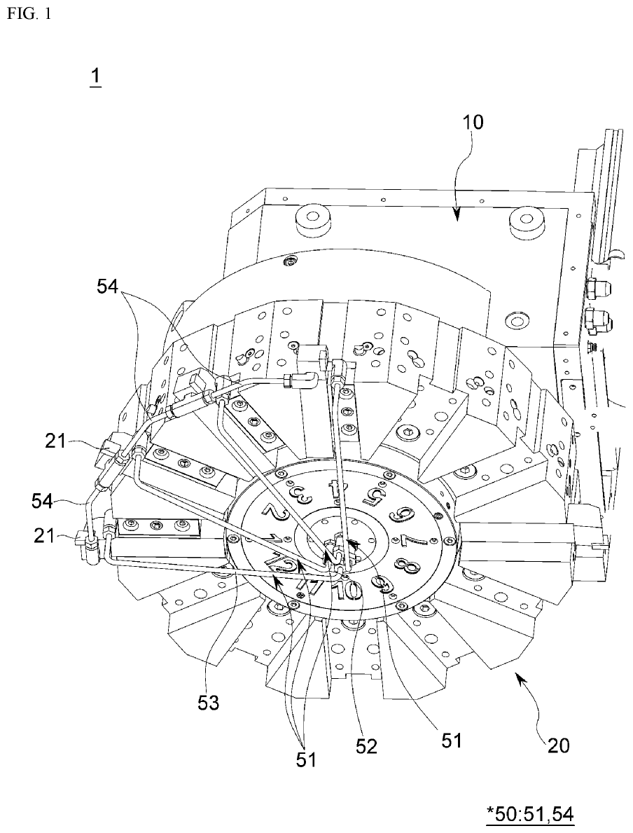

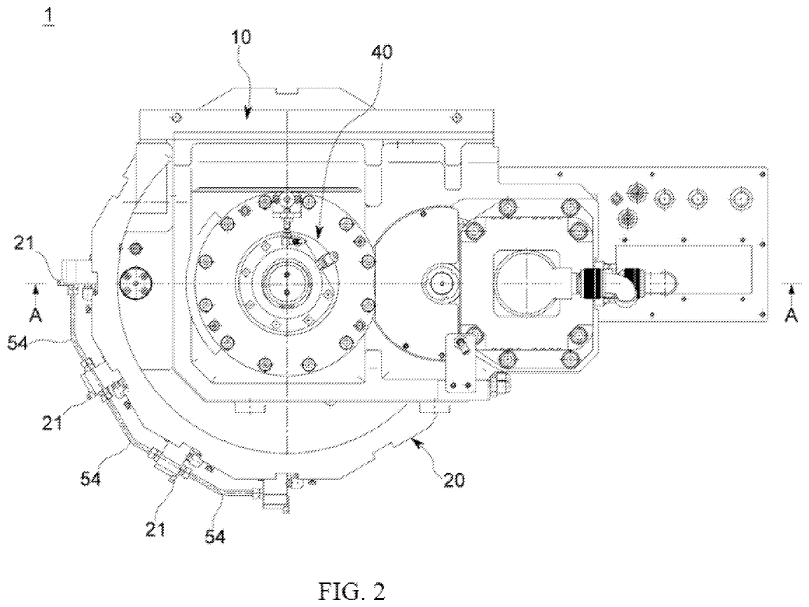

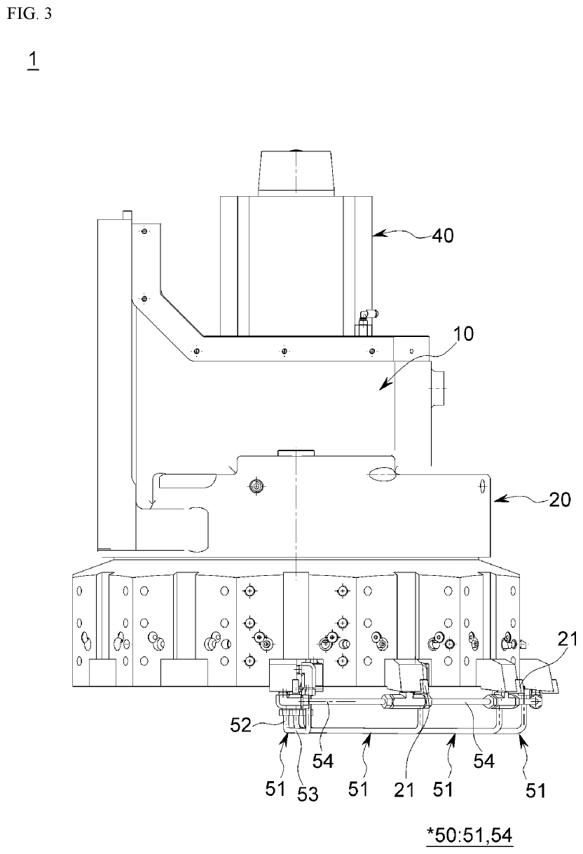

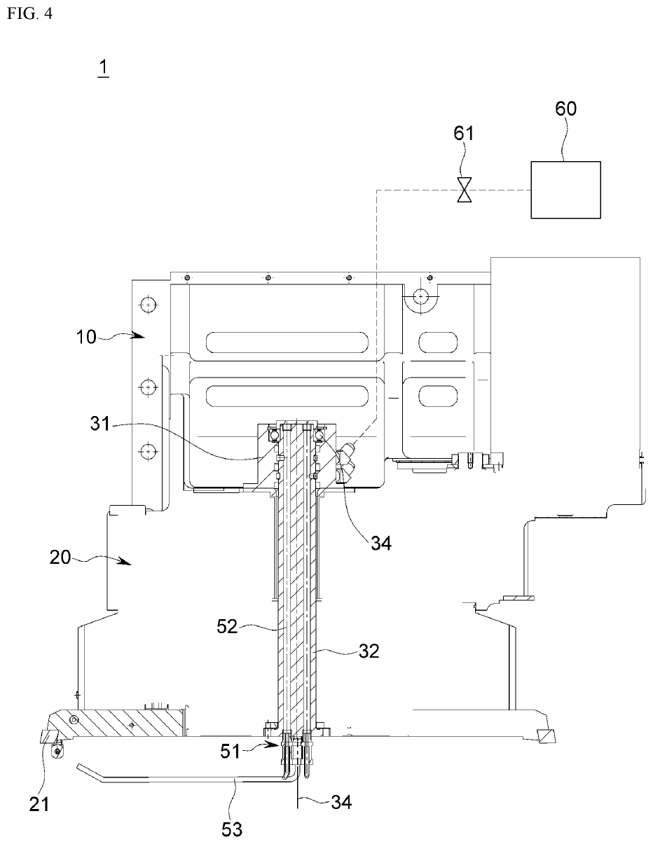

FIG. 1 is a perspective view of a turret tool cooling apparatus according to the present disclosure, and FIG. 2 is a top plan view of the turret tool cooling apparatus according to the present disclosure. FIG. 3 is a side view of the turret tool cooling apparatus according to the present disclosure, and FIG. 4 is a cross-sectional view taken along line A-A illustrated in FIG. 2.

The terms used below are defined as follows. The term “horizontal direction” means a direction parallel to a rotation axis, and the term “vertical direction” means a direction orthogonal to a horizontal direction and perpendicular to the rotation axis. In addition, the term “inward (inner)” means a side relatively close to a center of the same member, i.e., the inside, and the term “outward (outer)” means a side relatively distant from the center of the same member, i.e., the outside.

A turret tool cooling apparatus 1 according to the present disclosure will be described with reference to FIGS. 1 to 4. As illustrated in FIGS. 1 to 4, the turret tool cooling apparatus 1 according to the present disclosure includes tool stand body 10, a turret 20, an indexing unit 30, a driving unit 40, and a cooling flow path 50.

The tool stand body 10 is installed on a bed or a part of a body of a machine tool that is not illustrated in the drawings.

The turret 20 is installed on the tool stand body 10 and accommodates a plurality of tools 21. The turret 20 may receive various tools including a cutting tool required to machine a workpiece of the machine tool, tools used to perform outer diameter turning and inner diameter turning, and tools required for drilling or milling.

Specifically, the turret 20 is divided into angular sections based on the rotation axis 33 and radially accommodates the plurality of tools. FIGS. 1 to 4 illustrate that the turret is divided into 12 angular section each having an angle of 30 degrees, but the present disclosure is not necessarily limited thereto. The turret may be divided at a desired angle, as necessary.

That is, as necessary, the turret of the turret tool cooling apparatus according to the present disclosure may be divided into 36 angular sections each having an angle of 10 degrees, 24 angular sections each having an angle of 15 degrees, 9 angular sections each having an angle of 40 degrees, 6 angular sections each having an angle of 60 degrees, 5 angular sections each having an angle of 90 degrees, 3 angular sections each having an angle of 120 degrees, or 2 angular sections each having an angle of 180 degrees.

The indexing unit 30 is installed over the turret and the tool stand body to index the plurality of tools 21 accommodated in the turret 20. In addition, according to the exemplary embodiment of the present disclosure, the indexing unit 30 may be configured as a rotary union.

That is, as illustrated in FIG. 4, the indexing unit 30 of the turret tool cooling apparatus according to the present disclosure includes a housing part 31, a shaft part 32, and/or a bearing part 34.

The housing part 31 is fixedly installed in the tool stand body 10.

The shaft part 32 is provided in the form of a cylindrical hollow pipe in which an internal space is formed through the cylindrical hollow pipe. One side of the shaft part 32 is rotatably coupled to the housing part 31 by means of a bearing. In addition, the shaft part 32 is installed to extend and penetrate the turret and rotated by an operation of the driving unit 40.

That is, the other side of the shaft part 32 extends to penetrate the inside of the turret. A horizontal portion of a main flow path part to be described below is disposed in a through-groove portion along an inner through-groove of the shaft part.

One or more bearing parts 34 are installed between a fixing part and the shaft part and support a rotation of the shaft part so that the shaft part may be rotated by the operation of the driving unit.

Because the indexing unit is configured as the rotary union structure as described above, a cryogenic cooling fluid may be continuously supplied directly to the tool, which performs the machining, without separating a cooling unit or interruption when the turret performs the indexing. Therefore, it is possible to prevent a leak of the cryogenic cooling fluid and block the introduction of chips.

The driving unit 40 is installed in the tool stand body 10 and provides rotational power to the indexing unit 30. That is, the driving unit 40 selectively provides rotational power to the turret 20 to rotate the turret 20 so that the desired tool, among the plurality of tools 21 accommodated in the turret, may machine the workpiece.

The driving unit 40 may be configured as a servo motor, but the present disclosure is not necessarily limited thereto. In addition, the drive unit 30 is operated based on an instruction of a PLC or a numerical control unit.

In addition, the numerical control unit includes numerical control (NC) or computerized numerical control (CNC) and is embedded with various types of numerical control programs.

That is, the numerical control unit is embedded with a program for operating the servo motor which is the drive unit and a program for operating the tools, and the corresponding program is automatically loaded and executed based on the operation of the numerical control unit. In addition, the numerical control unit communicates with a main operating unit and the PLC through a predetermined protocol.

In addition, the main operating unit includes a screen display program and a data input program in accordance with a selection of a screen display and performs a function of displaying a software switch on a display screen in accordance with an output of the screen display program and a function of recognizing an ON/OFF state of the software switch and making an instruction about an input and an output for an operation of the machine.

In addition, the main operation unit has a monitor installed in or at one side of a housing or a casing of the machine tool and capable of displaying multifunctional switches or buttons and various types of information, but the present disclosure is not necessarily limited thereto.

The PLC (programmable logic controller) communicates with the numerical control unit or the main operating unit through the predetermined protocol and serves to make a control instruction through this communication. That is, the PLC operates by receiving a control instruction based on the numerical control program for the numerical control unit or the main operating unit.

The cooling flow path 50 delivers the cryogenic cooling fluid, which is supplied from a cryogenic cooling fluid storage unit 60, to the one or more tools 21 accommodated in the turret 20.

In addition, the cooling flow path 50 may be thermally insulated or vacuum-insulated. In addition, the cooling flow path may be provided in the form of an insulating tube. In addition, the cooling flow path is disposed to penetrate a part of the indexing unit.

Because the cooling flow path is disposed to penetrate a part of the indexing unit as described above, it is possible to consistently supply the cryogenic cooling fluid to the tool even when the turret performs the indexing.

In addition, as illustrated in FIG. 4, the cryogenic cooling fluid storage unit 60 is installed outside the turret tool cooling apparatus or inside or outside a cover of the machine tool and stores the cryogenic cooling fluid in order to supply the cryogenic cooling fluid to the tool through the cooling flow path.

The cryogenic cooling fluid may be liquefied nitrogen or liquefied carbon dioxide.

In addition, a valve 61 may be installed between the cryogenic cooling fluid storage unit and the cooling flow path. As described above, the valve is opened or closed under the control of the numerical control unit and adjust the supply amount of cryogenic cooling fluid in order to cool the machining tool during the indexing or the process of machining the workpiece or precool the standby tool.

Therefore, it is possible to prevent the waste of the cryogenic cooling fluid and a safety accident, minimize machining costs, and improve convenience for an operator.

As illustrated in FIGS. 1 to 4, the cooling flow path 50 of the turret tool cooling apparatus 1 according to the present disclosure includes a main flow path part 51.

The main flow path part 51 extends while penetrating the shaft part so as to be adjacent to any one of the plurality of tools radially accommodated in the turret so that one side of the main flow path part communicates with the cryogenic fluid storage unit 60, and the other side of the main flow path part is divided into angular sections based on a rotation axis 33.

In addition, the main flow path part is provided as a plurality of main flow path parts corresponding in number to the angular sections separated based on the rotation axis of the turret. Specifically, in case that the turret is divided into 36 angular sections each having an angle of 10 degrees, 36 main flow path parts of the cooling flow path may be installed in the turret tool cooling apparatus according to the present disclosure.

However, two to ten main flow path parts may be provided in consideration of a diameter of the shaft part or an inner diameter of the through-groove portion. That is, as illustrated in FIGS. 1 to 4, in case that the turret is divided into 12 angular sections each having an angle of 30 degrees based on the rotation axis, four main flow path parts may be installed so that the two to four main flow path parts are adjacent to the tools of the divided turret, one main flow path part for each of the tools.

In addition, as illustrated in FIGS. 1 to 4, the main flow path part 51 of the cooling flow path of the turret tool cooling apparatus according to the present disclosure includes a horizontal portion 52 and a vertical portion 53.

The horizontal portion 52 extends while penetrating the shaft part 32 so as to be parallel to the rotation axis 33 of the shaft part.

The vertical portion 53 is bent from an outer tip of the horizontal portion 52 and extends perpendicular to the rotation axis 32 of the shaft part.

Both the horizontal portion and the vertical portion may each provided in the form of an insulating tube.

Because the main flow path part of the turret tool cooling apparatus according to the present disclosure is disposed to penetrate the shaft part of the indexing unit having the rotary union structure as described above, the cryogenic cooling fluid may be continuously supplied directly to the tool, which performs the machining, without separating the cooling flow path or interruption even when the turret performs the indexing. Therefore, it is possible to prevent a leak of the cryogenic cooling fluid and block the introduction of chips.

In addition, the main flow path part of the turret tool cooling apparatus according to the present disclosure has a structure in which the shaft part is connected directly to the tool radially accommodated in the turret divided into the angular sections based on the rotation axis. Therefore, it is possible to maximize the cooling efficiency by reducing the pipe resistance against the cryogenic cooling fluid being delivered to the main flow path part.

As illustrated in FIGS. 1 to 4, the cooling flow path 50 of the turret tool cooling apparatus 1 according to the present disclosure further includes an auxiliary flow path part 54.

The auxiliary flow path part 54 is provided to connect tips of the adjacent main flow path parts 51 from which the cryogenic cooling fluid is discharged. One or more auxiliary flow path parts 54 are formed to precool the standby tool with the cryogenic cooling fluid discharged from the tip of the main flow path part for cooling the machining tool.

That is, the auxiliary flow path part 54 is installed to connect the tips of the vertical portions 53 of the adjacent main flow path parts 51 adjacent to the tool and receives the cryogenic cooling fluid discharged from the tips of the vertical portions of the main flow path parts in order to cool the corresponding machining tool without discharging the cryogenic cooling fluid to the outside. Therefore, the auxiliary flow path part 54 may cool the adjacent standby tool or precool the standby tool to be machined next according to the machining program, thereby maximizing the resources, preventing the waste of the cryogenic cooling fluid, and reducing the machining costs.

Specifically, the auxiliary flow path part 54 has the similar angular shape to the entire external shape of the turret and extends to connect the tips of the vertical portions of the adjacent main flow path parts from which the cryogenic cooling fluid is discharged, in order to deliver, to the standby tools, the cryogenic cooling fluid discharged from the tip of the vertical portion of the main flow path part to the standby tools accommodated along an outer peripheral surface of the turret 20 that is divided into the angular sections based on the rotation axis 33 of the turret 20 and radially accommodates the plurality of tools.

Therefore, according to the turret tool cooling apparatus according to the present disclosure, the plurality of main flow path parts is disposed to be connected directly to the tools radially accommodated in the turret divided into the angular sections based on the rotation axis of the shaft part. The plurality of auxiliary flow path parts is provided between the main flow path parts cool the standby tool adjacent to the machining tool or precool the standby tool to be machined next according to the machining program. Therefore, it is possible to reduce the non-machining time, maximize the productivity, minimize the waste of the cryogenic cooling fluid, increase the tool lifespan, reduce the maintenance costs, improve the machining precision. Further, with the direct connection structure, it is possible to reduce the size, improve the spatial utilization. Further, it is possible to reduce the manufacturing cost and manufacturing time by eliminating the installation of a separate actuator for connecting and blocking the flow path during the indexing in the related art.

While the present disclosure has been described above with reference to the exemplary embodiments of the present disclosure in the detailed description of the present disclosure, it may be understood, by those skilled in the art or those of ordinary skill in the art, that the present disclosure may be variously modified and changed without departing from the spirit and scope of the present disclosure disclosed in the claims. Accordingly, the technical scope of the present disclosure should not be limited to the contents disclosed in the detailed description of the specification but should be defined only by the claims.

### DESCRIPTION OF MAIN REFERENCE NUMERALS OF DRAWINGS

1: Turret tool cooling apparatus

10: Tool stand body

20: Turret

30: Indexing unit

31: Housing part

32: Shaft part

33: Rotation axis

34: Bearing part

40: Cooling flow path

41: Main flow path part

42: Horizontal portion

43: Vertical portion

44: Auxiliary flow path part

50: Cryogenic cooling fluid storage unit

60: Valve

1. A turret tool cooling apparatus comprising:
a tool stand body;
a turret installed on the tool stand body and configured to accommodate a plurality of tools;
an indexing unit configured to index the plurality of tools accommodated in the turret;
a driving unit installed in the tool stand body and configured to provide rotational power to the indexing unit; and
a cooling flow path configured to deliver a cryogenic cooling fluid, which is supplied from a cryogenic cooling fluid storage unit, to one or more tools accommodated in the turret,
wherein the cooling flow path is disposed to penetrate a part of the indexing unit, such that a cryogenic cooling fluid is consistently supplied even when the turret performs the indexing.

2. The turret tool cooling apparatus of claim 1, wherein the indexing unit comprises:
a housing part installed in the tool stand body; and
a shaft part having one side coupled to the housing part, the shaft part installed to extend while penetrating the turret and being configured to be rotated by an operation of the driving unit.

3. The turret tool cooling apparatus of claim 2, wherein the cooling flow path comprises a plurality of main flow path parts each having one side configured to communicate with the cryogenic fluid storage unit, and the other side extending while penetrating the shaft part so as to be adjacent to any one of the plurality of tools radially accommodated in the turret to be divided into angular sections based on a rotation axis.

4. The turret tool cooling apparatus of claim 3, wherein the cooling flow path further comprises one or more auxiliary flow path parts configured to connect tips of the adjacent main flow path parts, from which the cryogenic cooling fluid is discharged, and precool a standby tool with the cryogenic cooling fluid discharged from the tip of the main flow path part that cools a machining tool.

5. The turret tool cooling apparatus of claim 4, wherein the main flow path part comprises:
a horizontal portion extending while penetrating the shaft part so as to be parallel to the rotation axis of the shaft part; and
a vertical portion bent from the tip of the horizontal portion and extending perpendicularly to the rotation axis of the shaft part.

6. The turret tool cooling apparatus of claim 5, wherein the indexing unit further comprises a bearing part installed between the fixing part and the shaft part and configured to support a rotation of the shaft part.
